(19) United States
(12) Patent Application Publication
(10) Pub. No.: US 2008/0050610 A1
(43) Pub. Date: Feb. 28, 2008

(54) Method for manufacturing an at least partially porous, hollow silicon body, hollow silicon bodies manufacturable by this method, and uses of these hollow silicon bodies

(76) Inventors: Michael Stumber, Korntal-Muenchingen (DE); Ralf Reichenbach, Esslingen (DE); Tjalf Pirk, Leonberg (DE); Ando Feyh, Tamm (DE); Dick Scholten, Stuttgart (DE); Christian Maeurer, Leonberg (DE)

Correspondence Address: KENYON & KENYON LLP, ONE BROADWAY, NEW YORK, NY, 10004, US

(21) Appl. No.: 11/821,979

(22) Filed: Jun. 25, 2007

(30) Foreign Application Priority Data
Jun. 23, 2006 (DE) 102006028915.3

(51) Int. Cl. B32B 3/26; C25F 3/16

(52) U.S. Cl. 428/596; 205/666

(57) ABSTRACT

A method for manufacturing an at least partially porous, hollow silicon body, including the steps of vertical, anisotropic etching, porosifying, and electropolishing. Hollow silicon bodies manufactured using this method; the body wall including an inner layer, an intermediate layer, and an outer layer, and the porosity of the intermediate layer being greater than those of the inner and outer layers. The use of the hollow silicon bodies.

### BACKGROUND INFORMATION

It is clinically routine to use a number of application ways for administering drugs: gastrointestinal (rectal, oral), transdermal, intravenous, intramuscular, pulmonary, etc. Each of these methods has its particular characteristics and the advantages and disadvantages associated with it.

Small, porous-silicon spherules that are as round as possible are needed for medical applications. In the case of injecting such spherules into the blood stream, the diameter should particularly be less than 5 μm in order that no vessels are blocked. On the other hand, larger particles, by which vessels can be deliberately closed and an accumulation of the particles can be achieved, are also used and needed in medical science. An example of a possible application of these is radioactive tracers, which collect in organs and thus allow an analysis of blood flow. A further conceivable application is the deliberate prevention of blood flow, e.g., in oncology.

In imaging methods for representing blood vessels, for example, substances are frequently used which effectively form an image of the vessels due to their x-ray signature or their relaxation characteristics in MRI (magnetic resonance imaging) methods. However, these substances can stress the patient. Therefore, a new way of rendering vessels visible by imaging methods is desirable.

A further aspect is an effectively controllable level of active substance in the patient. To date, only rather complicated, invasive methods such as continuous infusion have allowed stable levels to be achieved. After an injection or gastrointestinal dose of a drug, a rapid increase in the level of active substance normally sets in, which then continuously decreases due to distribution, metabolism, and elimination. This is, above all, problematic in the case of active substances whose therapeutic window is quite narrow. Therefore, overshoot and undershoot of the optimum level of active substance are frequent in practice.

PCT Patent Publication No. WO 2001/76564 describes a particular product including at least one microparticle, at least one of the microparticles containing silicon. This document relates to devices and components, which are used in the microprojectile implementation of the particular product into a target of cells or tissue. The microprojectiles may include porous silicon, and active substances may be at least partially present in the pores of the porous silicon. This document describes a particular product as well, at least one of the microprojectiles including a cavity, which is at least partially delimited by porous and/or microcrystalline silicon, and active substances being at least partially contained in the cavity.

The pores or the porosity of this silicon particle increases here from the interior of the particle outwards. This means, for the active substance contained in the pores, that its diffusion out of the pores is not subjected to any further resistance. Therefore, the release characteristic corresponds more to that of a conventional administration, i.e., including an initially sharp increase in the active-substance concentration, followed by a continuous decrease.

The method described there for manufacturing essentially spherical silicon particles includes the secondary treatment of the non-spherical particles initially obtained, using grinding or etching steps, in order to round off the edges of the particles.

Consequently, there is a need in the related art for a method to manufacture porous, hollow silicon bodies, which is capable of producing essentially spherical particles and may be implemented with lower equipment costs. There is also a need for hollow silicon bodies manufacturable by such methods, which have a more uniform release characteristic for active substances.

### SUMMARY OF THE INVENTION

The method of the present invention relates to a method for manufacturing an at least partially porous, hollow silicon body, including the steps:
(a) passivating and masking the surface of a silicon body,
(b) vertical, anisotropic etching step, where the vertical walls are passivated,
(c) porosifying the silicon delimiting the channel formed in step (b), by applying a current-density profile which includes applying at least a current density J1 for a period of time t1, and
(d) electropolishing.

The surface of the silicon body may be passivated in step (a) by doping, e.g., n-doping in a p-doped substrate, and depositing carbide layers such as SiC, oxide layers such as SiO₂, and/or nitride layers such as Si₃N₄. The masking layer may be patterned by applying a positive or negative photoresist, irradiating it using a photomask, and subsequently removing the regions irradiated or not irradiated, depending on the photoresist used. For example, a pattern of circular recesses in the photoresist may be obtained which uncover the passivated surface of the silicon body. It is further possible to remove the passivation layer freed from the photoresist, using, for example, plasma methods or HF etching, in order to uncover the underlying silicon surface.

Undoped, n-doped and, in particular, p-doped silicon are suitable as a material for the silicon body. Commercially available silicon wafers may be used, for example.

An anisotropic etching step takes place in step (b), the etching direction being from the surface of the silicon body into the depth. The etching may preferably take place in a dry manner, e.g., using a trench process in a plasma reactor.

As an alternative, such a pattern may also be produced with the aid of wet-chemical processes employing alkaline etching reagents. Alkaline etching reagents, such as KOH, NaOH, CsOH, ethylenediamine, pyrocatechol, and/or hydrazine hydrate, may be used. The etching reagents represented here are distinguished in that the highest etching rate is in the (110) direction of the silicon crystal. On the other hand, the addition of additives such as isopropanol allows etching to take place most rapidly along the (111) direction.

After the etching of the channel, the channel wall may be passivated, for example, by depositing nitride or carbide layers. The passivation at the base of the channel may be removed with the aid of methods such as reactive ion etching (RIE).

In step (c), a first porous layer in the silicon is produced by applying a current-density profile, which at least includes applying a current density J1 for a first period of time t1. Current-density profile is to be generally understood as successively applying different current densities for specific periods of time. In the present case, current density J1 may be, for example, ≧1 mA/cm² to ≦500 mA/cm², ≧50 mA/cm² to ≦300 mA/cm² or ≧100 mA/cm² to ≦200 mA/cm². Time t1 may be ≧1 s to ≦1000 s, ≧10 s to ≦300 s or ≧50 s to ≦200 s. A preferred combination is a value of 100 mA/cm² for 60 s. In this porosifying step, the silicon body is connected as an anode and the electrolyte is connected as a cathode. It is possible to additionally radiate the silicon body with visible and/or UV light, in order to control the porosification.

Electropolishing is subsequently carried out in step (d). This means that a current density is applied, which results in the dissolution of the silicon bordering on the layer formed in step (c). The current density may be, for example, ≧10 mA/cm² to ≦2500 mA/cm², ≧70 mA/cm² to ≦100 mA/cm² or ≧100 mA/cm² to ≦200 mA/cm². This step may also be carried out in the same system as the preceding method steps.

The formation of hydrogen gas during the electropolishing step may allow the hollow silicon body obtained to be pressed out of the substrate and float on the electrolyte. In this case, any passivation layer present on the substrate surface is broke. The hollow silicon bodies obtained may now be gathered, cleaned, and filled with active substances.

For example, the active substances may be dissolved in supercritical CO₂ (scCO₂), and the hollow silicon bodies may be filled with this solution. After the CO₂ evaporates, the active substance then remains in the pores. At the end of the filling, the active substance may be washed out of the inner cavity or channel, in order that the active substance does not escape in an indefinite manner during administration. As an alternative, however, active substance may also be left in the inner cavity, in order to rapidly administer a high starting dose, which is then supplemented by a continuous release over a long period of time. This is important, for example, for pain therapy.

The cleaning and/or functionalization may also be carried out on the wafer level plane. More powerful passivation or a different selection of process parameters, which prevent the passivation layer from breaking up after exposure of the hollow silicon body via electropolishing, cause the hollow silicon bodies obtained to remain in the wafer while they are cleaned and functionalized. The passivation layer may be subsequently removed with the aid of suitable etching methods such as wet-chemical etching or plasma etching, in order to release the hollow silicon bodies.

It is furthermore possible and provided, that the electrolyte be replaced during the individual method steps. For example, the concentration of the etching reagent may be changed in order to influence the porosification of the silicon.

### SUMMARY OF THE INVENTION

Consequently, the method of the present invention allows porous, hollow silicon bodies having rounded-off edges, or even essentially spherical and porous, hollow silicon bodies, to be manufactured in a single system. It is no longer necessary to grind particles in order to lend them a less angular or essentially spherical shape. The elimination of the grinding step allows hollow bodies having very thin silicon walls and/or high porosities to be manufactured, which would not mechanically survive the hitherto conventional manufacturing methods.

### BRIEF DESCRIPTION OF THE DRAWINGS

FIG. 1a shows a step in the method of the present invention.

FIG. 1b shows a further step in the method of the present invention.

FIG. 1c shows a further step in the method of the present invention.

FIG. 2 shows a porous, silicon microsphere manufacturable according to the method of the present invention.

### DETAILED DESCRIPTION

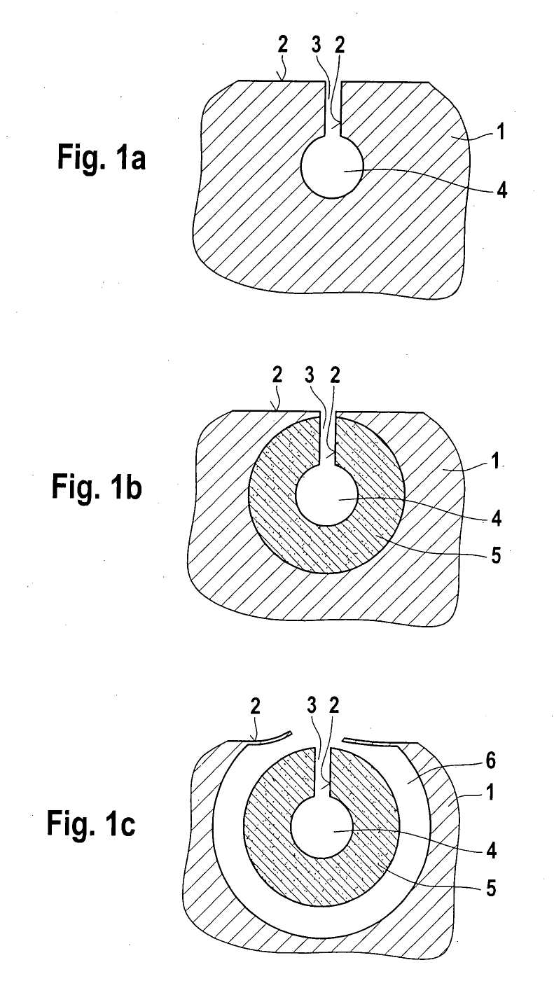

The method of the present invention will now be explained in detail in view of the partial steps in FIGS. 1a, 1b and 1c.

FIG. 1a shows a silicon wafer (1) having passivated surfaces (2). A channel (3) was anisotropically etched into the wafer. An isotropic etching step was carried out at the base of the channel to form essentially spherical cavity (4).

FIG. 1b shows the same silicon wafer after porosification. An essentially spherical zone of porosified silicon (5) has formed, whose center is at the center of cavity (4).

FIG. 1c shows the situation after the electropolishing. Material was removed adjacent to the porosified silicon to form free space (6). It is apparent that part of passivated surface (2) has broken off.

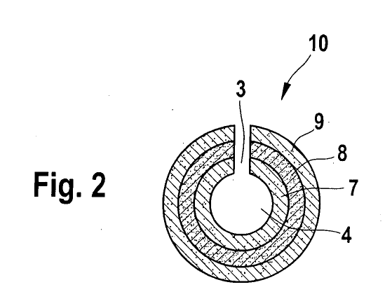

FIG. 2 shows a porous silicon microsphere (10) according to the present invention. It has a channel (3), an inner cavity (4), a porous inner layer (7), a porous intermediate layer (8), and a porous outer layer (9). The wall of the microsphere is formed by the three layers (7), (8), and (9). The graphical representation clearly shows that intermediate layer (8) has a higher porosity than the inner (7) and the outer (9).

In one specific embodiment of the method according to the present invention, the current-density profile in step (c) includes the application of further current densities J2 through Jn for further periods of time t2 through tn, n being able to assume an integral value of ≧3 to ≦15, preferably ≧3 to ≦7, and especially ≧4 to ≦5. This is to be understood to mean that after current density J1 is applied for a period of time t1, a further current density J2 is applied for a period of time t2, and subsequently a further current density J3 for a period of time t3, and so on.

Current densities J2 through Jn may assume, independently of one another, values of ≧1 mA/cm² to ≦1000 mA/cm², ≧50 mA/cm² to ≦500 mA/cm² or ≧100 mA/cm² to ≦300 mA/cm². Times t2 through tn may assume, independently of one another, values of ≧1 s to ≦1000 s, ≧50 s to ≦700 s or ≧100 s to ≦400 s.

This allows a series of layers of differing porosities to be formed. It is advantageous for first current density J1 and last current density Jn to be greater than intermediate current densities J2 and Jn-1. This allows the outermost layers to have a lower porosity than the layer(s) situated further inside. Consequently, the method according to the present invention allows porous, hollow silicon bodies, whose walls are more porous on the inside than on the outside, to be manufactured in a single manufacturing step, or in a single piece of production equipment.

It is additionally possible for the quotient of second current density J2 and the average value of first current density J1 and third current density J3 to be in a range of ≧1.5 to ≦20, preferably ≧3 to ≦15, and especially ≧5 to ≦10. The selection of the current densities influences the obtained porosities of the layers in a particular manner. The ratio of the current densities expressed in this manner allows the operator of the method according to the present invention to process silicon bodies of any thickness and manufacture porous, hollow silicon bodies from them according to the present invention.

It is additionally possible for the quotient of second period of time t2 and the average value of first period of time t1 and third period of time t3 to be in a range of ≧1.5 to ≦20, preferably ≧3 to ≦15, and especially ≧5 to ≦10. The selection of the porosifying times influences the thickness of the porosified layers in a particular manner. The ratio of the porosifying times expressed in this manner allows the operator of the method according to the present invention to process silicon bodies of any thickness and manufacture porous, hollow silicon bodies from them according to the present invention.

In a further specific embodiment of the method according to the present invention, the current-density profile in step (c) includes a temporally continuous change in the current density. This allows a porosity gradient to be formed in the material. This also allows a maximum porosity to be formed in the interior of the material to be porosified, and allows the porosity at the edges to be designed to be low. Porosity gradients are advantageous, since the continuous change in the porosity allows the material to have fewer weak points than material having an abrupt porosity difference.

In a further specific embodiment of the method according to the present invention, an additional step (bb) is carried out after step (b); the additional step (bb) including an isotropic etching step starting at the base of the channel formed in step (b), and a cavity being formed. Examples of isotropic etching reagents include HF, HF/NH₄F, and/or HF/HNO₃/CH₃CO₂H/H₂O. This isotropic etching step leads to the formation of a cavity under the surface of the silicon body. Since the walls of the channel were passivated in step (b), they are not attacked by the isotropic etching step. In this manner, the channel now leading to the newly formed cavity is preserved. Another variant includes the switchover from anisotropic to isotropic etching in a plasma reactor.

The subject matter of the present invention further includes a hollow silicon body, including a body wall and at least one channel through the body wall, the hollow silicon body being able to be manufactured using a method of the present invention, the body wall including an inner layer, at least one intermediate layer, and an outer layer, and the porosity of the intermediate layer being greater than those of the inner and outer layers.

In this connection, the inner layer is to be understood as the layer closest to the channel through the body wall. In the same manner, the outer layer is to be understood as the layer, which, with the exception of the channel or the channel wall, outwardly delimits the silicon body of the present invention.

In the spirit of the present invention, “porosity” is defined in such a manner, that it indicates the empty space within the pattern and the remaining substrate material. It may either be determined optically, i.e., from an evaluation of, e.g., microscopic photographs, or chemically. In the case of chemical determination, the following applies:

Porosity P=(m₁−m₂)/(m₁−m₃), where mₗ is the mass of the sample prior to porosification, m₂ is the mass of the sample after porosification, and m₃ is the mass of the sample after etching it with a 1 molar NaOH solution that chemically dissolves the porous structure.

With regard to their size, the pores of the porous layers may be referred to as nanopores, mesopores, and/or macropores. Pores having a size in the range of ≧0.1 nm to ≦2 nm may be referred to as nanopores. Mesopores are pores having a size between ≧2 nm und ≦50 nm. Finally, macropores are pores having a size of ≧50 nm. A plurality of types of the above-mentioned pores may occur in the individual porous layers. The pores may also assume the form of pore channels. In addition, e.g., in a macroporous layer, cross-connections between the individual pore channels may be produced by mesopores.

The pore channels referred to by the present invention preferably run, in their main direction, at right angles to the surface of the body wall of the hollow silicon body. They may assume the shape of individual channels or may also be connected among each other by cross-connections, so that an open pore pattern is formed. It is provided that the pore channels of the layer of the hollow silicon body situated between the outer layers are in communication with them, i.e., that a connection is produced between the interior of the body and its surroundings. Since the main direction of the pore channels is perpendicular to the body wall surface, and thus parallel to the channel running through the body wall, lateral diffusion directly into the channel is negligible. In addition, the passivation protects the inner walls of the channel against penetration of the active substance.

The utilized material, silicon, has the advantage that it is biocompatible and chemically inert with respect to the vast majority of active-substance molecules. Silicon introduced into the body is not expelled, but rather metabolized and excreted over time.

First of all, a hollow silicon body of the present invention has a large amount of hollow space in its interior. After the hollow silicon bodies are administered, the air contained in the hollow space may be used as a contrast medium in imaging methods such as MRI and x-ray imaging; the contrast medium being effective and, above all, not causing the patient any side-effects.

In addition, a hollow silicon body according to the present invention permits greater amounts of active substances to be stored in its intermediate, i.e., inner layer. In this case, due to the higher porosity, an active-substance reservoir is therefore present, from which the active substance may defuse through the outer layers. The lesser porosity and possibly smaller pore size of the outer layers determine the exact behavior of the diffusion of the active substance out of the hollow silicon body. In this connection, one may also speak of a decoupling of the reservoir and membrane. This permits a nearly constant release of the active substance over a longer period of time than in the case of conventional, one-time administration. Since the pore channels are situated so as to be orthogonal to the main plane of the body, the diffusion of the active substance through the lateral surfaces of the channel is negligible.

The hollow silicon body of the present invention may have a radius of ≧0.1 μm to ≦300 μm, preferably ≧0.5 μm to 20 μm, and especially ≧5 μm to ≦10 μm. The channel diameter may be ≧0.1 μm to ≦20 μm, preferably ≧0.5 μm to ≦10 μm, and especially ≧1 μm to ≦4 μm.

It is preferable for the hollow silicon body of the present invention to assume a spherical or approximately spherical shape. In this connection, “approximately spherical” is to be understood as meaning that the distance from the center of the body to a point on the outer surface of the body does not differ from the distance to a different point on the outer surface of the body by more than ≦30%, preferably ≦15%, and especially ≦10%. The channel through the body wall is not taken into account in these deliberations.

In one exemplary embodiment of the present invention, the hollow silicon body additionally contains an inner cavity, the channel leading through the body wall to the inner cavity. Consequently, the hollow silicon body contains an additional reservoir for releasing an active substance without diffusion through porous walls. This is important for pain therapy, when a particular amount of active substance must be immediately released, followed by a further, continuous administration.

In a further exemplary embodiment of the present invention, the body wall contains pores having an average pore size of ≧0.5 nm to ≦500 nm, preferably ≧2 nm to ≦150 nm, and especially ≧5 nm to ≦50 nm. Such pore sizes allow the hollow space and, consequently, the storage capacity for active substances to be maximized without affecting the mechanical strength of the hollow silicon body. Therefore, the hollow silicon body of the present invention may run through the necessary manufacturing and administration steps without the risk of being damaged. In addition, the amount and rate of the active substance diffusing out of the body wall may be selectively adjusted to the pharmacological profile of the specific active substance.

It is provided that the porosity of the intermediate layer used as an active-substance reservoir be in a range of ≧10% to ≦80%, preferably ≧40% to ≦70%, and especially ≧45% to ≦65.% It is additionally provided that the average value of the porosity of the inner and outer layers be in a range of ≧1% to ≦60%, preferably ≧5% to ≦40%, and especially ≧7% to ≦35%. Setting a suitable ratio of the porosities permits an active substance to remain in the interior of the hollow silicon body for a sufficiently long time and to diffuse out slowly and continuously. In this manner, for example, it may be provided that the hollow silicon body of the present invention, together with the active substance contained, only has to be administered once a day, once a week, or even in longer intervals.

In a further exemplary embodiment of the present invention, the quotient of the volume of the entire hollow silicon body and the volume of the inner cavity is in a range of ≧5 to ≦30000, preferably ≧50 to ≦5000, and especially ≧100 to ≦1000. The hollow space considered in this case includes the channel produced in step (b) of the method of the present invention, and, if present, the cavity additionally produced in step (bb) of the method of the present invention. These volume ratios allow a choice between rapidly filling the pores with active substance via the cavity, with simultaneously good mechanical strength of the hollow silicon body, and, as an alternative, maximizing the amount of contained air with simultaneously good mechanical strength. The latter is important when the hollow silicon body of the present invention is intended to be used as a contrast medium in MRI or x-ray analyses.

In a further exemplary embodiment of the present invention, the hollow silicon body of the present invention contains one or more active substances, preferably selected from the group including analgesics, anti-allergic agents, anti-arrhythmic agents, antibiotics, anti-diabetic agents, anti-emetics, antihypertensive agents, antimycotic agents, antiparasitic agents, dermatics, cardiacs, gastrointestinal remedies, opthalmics, wound-treatment agents, and/or cytostatic agents. Such active substances are well-suited for treating diseases where the drug is administered continuously. At the same time, patients, who are dependent on such active agents, benefit to a large extent from the lower amount of stress brought about by the more uniform level of active substance.

The subject matter of the present invention further includes the use of hollow silicon bodies according to the present invention for manufacturing an administration unit for medicines to treat pain, allergies, infections, cardiovascular diseases, cancer; the administration unit being suitable for direct administration and/or selective, local destruction of hollow silicon body (10) via ultrasonics, and/or suitable for contrast-medium preparations in MRI and/or x-ray analyses. To deliver the active substance, the hollow silicon body of the present invention may be injected as an implantable reservoir (subcutaneously, intramuscularly, intraperitoneally, intraosseously, etc.) or orally administered. The administration unit is to be understood as a product ready for use. It includes hollow silicon bodies of the present invention, the active substance(s), inactive ingredients such as auxiliary dispersing agents or stabilizers, as well as solvents. The above-mentioned ranges of indication particularly benefit from the option of being able to release active substances in a controlled manner and over a longer period of time, using the hollow silicon bodies of the present invention. On the other hand, hollow silicon bodies of the present invention loaded with active substance are suited for selective, local destruction with the aid of ultrasonics and, therefore, selective, local release of the active substance. This may reduce the stress on the patient, since the active substance is only released where it is also desired.

What is claimed is:

1. A method for manufacturing an at least partially porous, hollow silicon body, comprising the steps of:
(a) passivating and masking a surface of a silicon body;
(b) performing a vertical, anisotropic etching, wherein vertical walls are passivated;
(c) porosifying silicon delimiting a channel formed in step (b), by applying a current-density profile which at least includes applying a current density for a period of time; and
(d) performing an electropolishing.

2. The method according to claim 1, wherein the current-density profile in step (c) includes an application of further current densities J2 through Jn for further periods of time t2 through tn, and n being able to assume an integral value of ≧3 to ≦15.

3. The method according to claim 2, wherein n is ≧3 to ≦7.

4. The method according to claim 2, wherein n is ≧4 to ≦5.

5. The method according to claim 1, wherein the current-density profile in step (c) includes a temporally continuous change in the current density.

6. The method according to claim 1, further comprising, after step (b), performing an additional step (bb) which includes an isotropic etching step beginning at a base of the channel formed in step (b), and a cavity being formed.

7. A hollow silicon body, comprising:
a body wall; and
at least one channel through the body wall,
wherein the body wall includes an inner layer, at least one intermediate layer, and an outer layer, a porosity of the intermediate layer being greater than a porosity of the inner layer and the outer layer.

8. The hollow silicon body according to claim 7, further comprising an inner cavity, the channel leading through the body wall to the inner cavity.

9. The hollow silicon body according to claim 7, wherein the body wall contains pores having an average pore size of ≧0.5 nm to ≦500 nm.

10. The hollow silicon body according to claim 9, wherein the average pore size is ≧2 nm to ≦150 nm.

11. The hollow silicon body according to claim 9, wherein the average pore size is ≧5 nm to ≦50 nm.

12. The hollow silicon body according to claim 7, wherein a quotient of a volume of the entire hollow silicon body and a volume of an inner, hollow space is in a range of ≧5 to ≦30000.

13. The hollow silicon body according to claim 12, wherein the range is ≧50 to ≦5000.

14. The hollow silicon body according to claim 12, wherein the range is ≧100 to ≦1000.

15. The hollow silicon body according to claim 7, further comprising at least one active substance, selected from the group including analgesics, anti-allergic agents, anti-arrhythmic agents, antibiotics, anti-diabetic agents, anti-emetics, antihypertensive agents, antimycotic agents, antiparasitic agents, dermatics, cardiacs, gastrointestinal remedies, opthalmics, wound-treatment agents, and cytostatic agents.

16. The hollow silicon body according to claim 7, wherein the hollow silicon body is used for manufacturing an administration unit for medicines to treat at least one of pains, allergies, infections, cardiovascular diseases, and cancer; the administration unit being suitable for at least one of (a) a direct administration, (b) a selective, local destruction of the hollow silicon body via ultrasonics, and (c) contrast-medium preparations in at least one of MRI analyses and x-ray analyses.
